(19) United States
(12) Patent Application Publication
(10) Pub. No.: US 2015/0006691 A1
(43) Pub. Date: Jan. 1, 2015

(54) MANAGING ROGUE CLOUD PROVIDER OPERATIONS

(71) Applicant: Cisco Technology, Inc., San Jose, CA (US)

(72) Inventor: Soumendu S. Satapathy, Bangalore (IN)

(21) Appl. No.: 13/928,646

(22) Filed: Jun. 27, 2013

(51) Int. Cl. H04L 12/24

(52) U.S. Cl. CPC H04L 41/00
USPC 709/223

(57) ABSTRACT

In one embodiment, a cloud-based storage system determines acceptability of a plurality of internet addresses, and determines a defined action to take in response to unacceptable internet addresses. Accordingly, in response to a cloud-based data storage operation, the system determines a destination address where data blocks are physically being stored, determines whether the destination address is an acceptable internet address, and in response to the destination address being an unacceptable internet address, performs the defined action. In another embodiment, the system may insert a data deletion probe into a data volume of a cloud storage system, and in response to initiating a data deletion request for cloud-stored data blocks of the data volume, confirms physical deletion of the data blocks in response to a data deletion operation using the data deletion probe.

### TECHNICAL FIELD

The present disclosure relates generally to computer networks, and, more particularly, to managing rogue cloud provider operations.

### BACKGROUND

Cloud computing can be generally defined as Internet-based computing in which computing resources are dynamically provisioned and allocated to client or user computers or other devices on-demand from a collection of resources available via the network (e.g., “the cloud”). Cloud computing resources, for example, can include any type of resource such as computing, storage, and network devices, virtual machines (VMs), etc. For instance, resources may include service devices (firewalls, deep packet inspectors, traffic monitors, etc.), processing devices (brute force processing capability), storage devices (e.g., servers, network attached storages, storage area network devices), etc., and may be used for instantiation of VMs, databases, applications (Apps), etc.

There are certain security threats associated with certain cloud activities, such as the cloud provider migrates the data of the subscriber/customer to a geo-location which is not safe or which is more prone to disaster (e.g., by mistake). Even if the data in encrypted it is still being migrated to a rogue zone which may be prone to disaster or thefts, the customer may still not be comfortable with this migration, and may be particularly opposed to the risk when considering high-security data. Also, when a customer sends a request to delete its data (e.g., high-security data), then the cloud service provider, there is currently no way to determine whether the data has been actually physically deleted, or whether it was merely logically deleted.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 1 illustrates an example computer network;

FIG. 2 illustrates an example network device;

FIG. 3 illustrates an example storage area network;

FIG. 4 illustrates an example address acceptability table;

FIG. 5 illustrates an example simplified procedure for managing rogue cloud provider operations;

FIG. 6 illustrates an example logical block mapping;

FIG. 7 illustrates an example customer agreement mapping;

FIGS. 8A-8C illustrate examples of data deletion;

FIG. 9 illustrates an example view of application programming interfaces (APIs);

FIG. 10 illustrates another example simplified procedure for managing rogue cloud provider operations; and

FIG. 11 illustrates another example simplified procedure for managing rogue cloud provider operations, particularly with regard to data deletion.

### DESCRIPTION OF EXAMPLE EMBODIMENTS

### Overview

According to one or more embodiments of the disclosure, a cloud-based storage system determines acceptability of a plurality of internet addresses, and determines a defined action to take in response to unacceptable internet addresses. Accordingly, in response to a cloud-based data storage operation, the system determines a destination address where data blocks are physically being stored, determines whether the destination address is an acceptable internet address, and in response to the destination address being an unacceptable internet address, performs the defined action.

According to one or more additional embodiments of the disclosure, the system may insert a data deletion probe into a data volume of a cloud storage system, and in response to initiating a data deletion request for cloud-stored data blocks of the data volume, and confirms physical deletion of the data blocks in response to a data deletion operation using the data deletion probe.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others.

As mentioned above, cloud computing can be generally defined as Internet-based computing in which computing resources are dynamically provisioned and allocated to client or user computers or other devices on-demand from a collection of resources available via the network (e.g., “the cloud”), such as for example, processing, storage, applications, etc.

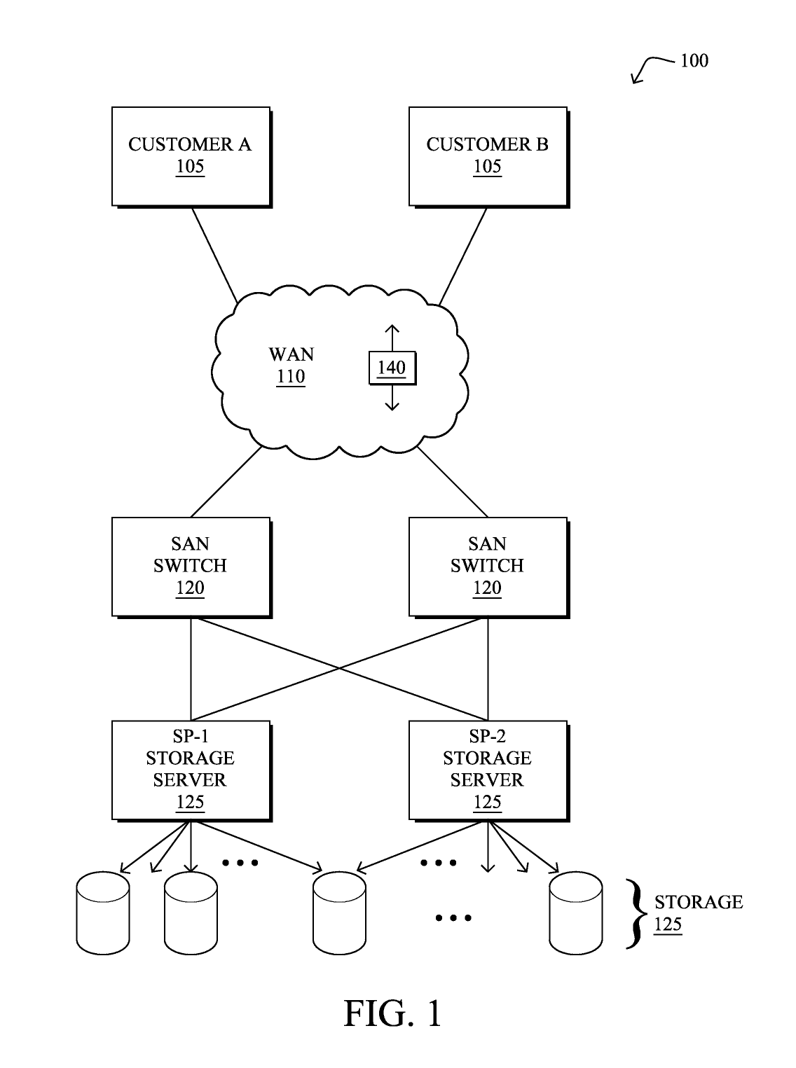

FIG. 1 is a schematic block diagram of an example computer network 100 in which cloud computing operations may take place, generally. The network 100 illustratively comprises a plurality of nodes/devices interconnected by various methods of communication. For instance, one or more customer devices 105 (personal computers, local servers, workstations, etc.), such as customer A and customer B, may be interconnected generally via a WAN 110 to one or more storage area network (SAN) switches 120, which can direct traffic (e.g., requests/responses) to/from one or more service provider (SP) storage servers 125, such as SP-1 and SP-2. The storage servers 125 may then direct the physical storage of data among a plurality of storage devices 130, which may be interspersed geographically across the globe. Data packets 140 (e.g., messages and/or data sent between the devices/nodes) may be exchanged among the nodes/devices of the computer network 100 using predefined network communication protocols. In this context, a protocol consists of a set of rules defining how the devices interact with each other. Those skilled in the art will understand that any number of nodes, devices, links, etc. may be used in the computer network, and they may be connected in a variety of different manners, that the view shown herein is for simplicity.

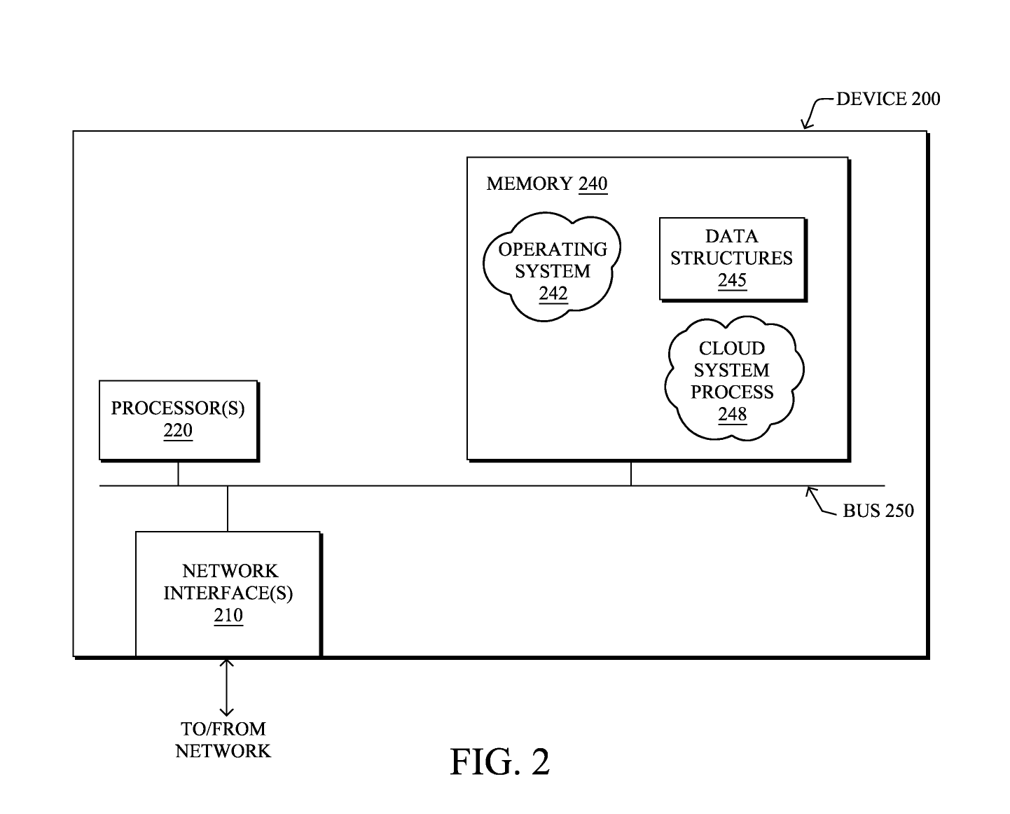

FIG. 2 is a schematic block diagram of a simplified example node/device 200 that may be used with one or more embodiments described herein, e.g., as any of the devices shown in FIG. 1 above. The device may comprise one or more network interfaces 210 (e.g., wired, wireless, etc.), at least one processor 220, and a memory 240 interconnected by a system bus 250.

The network interface(s) 210 contain the mechanical, electrical, and signaling circuitry for communicating data over links coupled to the network 100. The network interfaces may be configured to transmit and/or receive data using a variety of different communication protocols.

The memory 240 comprises a plurality of storage locations that are addressable by the processor 220 for storing software programs and data structures associated with the embodiments described herein. The processor 220 may comprise hardware elements or hardware logic adapted to execute the software programs and manipulate the data structures 245. An operating system 242, portions of which are typically resident in memory 240 and executed by the processor, functionally organizes the device by, inter alia, invoking operations in support of software processes and/or services executing on the device. These software processes and/or services may comprise an illustrative “cloud services” process 248, as described herein.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while processes may be shown and/or described separately, those skilled in the art will appreciate that processes may be routines or modules within other processes.

As noted above, there are certain security threats associated with certain cloud activities, such as the cloud provider migrates the data of the subscriber/customer to a geo-location which is not safe or which is more prone to disaster (e.g., by mistake). Even if the data in encrypted it is still being migrated to a rogue zone which may be prone to disaster or thefts, the customer may still not be comfortable with this migration, and may be particularly opposed to the risk when considering high-security data. The techniques described below allow the customer to be aware of this migration, and without the customer's consent the data should not be migrated to such a location. Also, when a customer sends a request to delete its data (e.g., high-security data), then the cloud service provider, there is currently no way to determine whether the data has been actually physically deleted, or whether it was merely logically deleted. If the data is logically deleted but not physically deleted, then the techniques herein allow the customer to discover this condition, and accordingly take corrective action (e.g., contact the cloud service provider). Otherwise, the customer may receive confirmation that the data has been physically deleted.

Specifically, according to one or more embodiments of the disclosure as described in detail below, a cloud-based storage system determines acceptability of a plurality of internet addresses, and determines a defined action to take in response to unacceptable internet addresses. Accordingly, in response to a cloud-based data storage operation, the system determines a destination address where data blocks are physically being stored, determines whether the destination address is an acceptable internet address, and in response to the destination address being an unacceptable internet address, performs the defined action. Further according to one or more additional embodiments of the disclosure, the system may insert a data deletion probe into a data volume of a cloud storage system, and in response to initiating a data deletion request for cloud-stored data blocks of the data volume, and confirms physical deletion of the data blocks in response to a data deletion operation using the data deletion probe.

Illustratively, the techniques described herein may be performed by hardware, software, and/or firmware, such as in accordance with the “cloud services” process 248, which may contain computer executable instructions executed by the processor 220 to perform functions relating to the techniques described herein, e.g., as an individual process/module and/or in conjunction with other processes/modules (e.g., hypervisors, handler code, probes, collaborative operations, etc.). For example, the techniques herein may be treated as extensions to conventional protocols, such as extensions to cloud storage protocols (e.g., for cloud providers that support hypervisors), and as such, may be processed by similar components understood in the art that execute those protocols, accordingly. In particular, the techniques herein provide instrumentation of various cloud components such as a cloud hypervisor, a volume manager, disk array firmware, and backup/replication software components in order to detect and prevent rogue service provider operations in a manner as described in detail below.

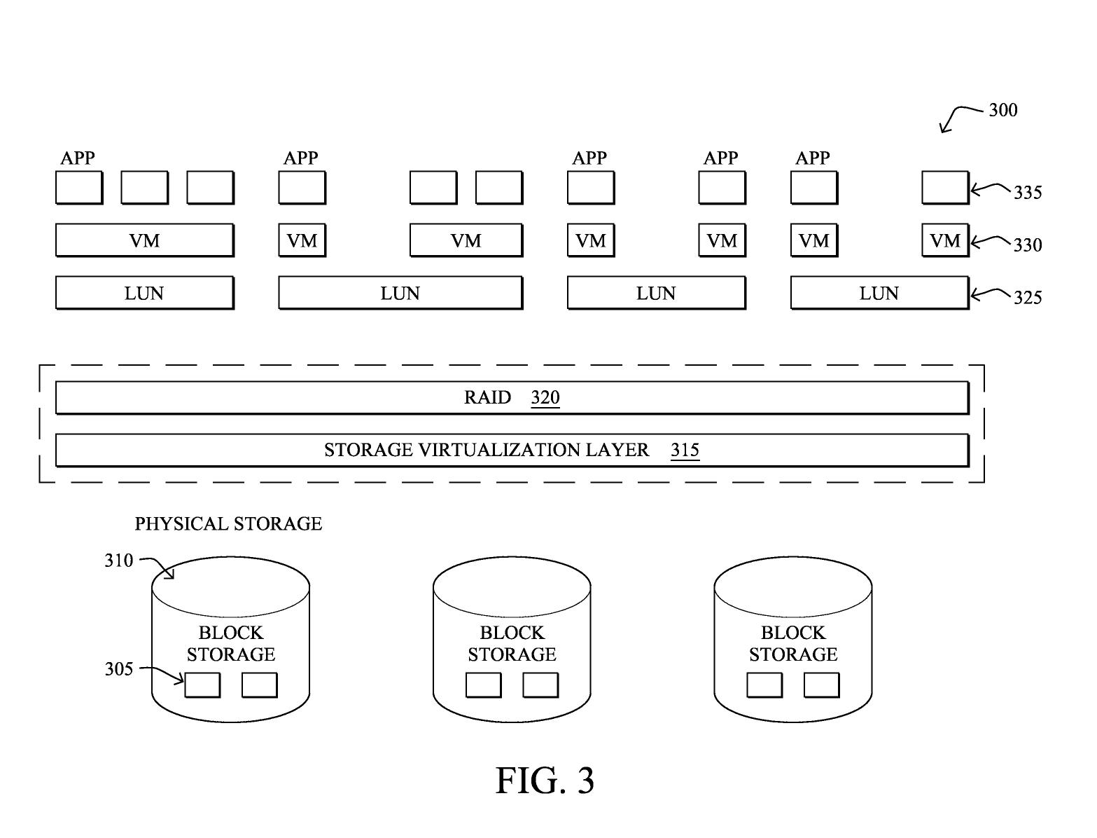

Notably, as an alternative (e.g., logical) view of the computer network of FIG. 1, FIG. 3 illustrates an example storage network 300, which may generally be appreciated by those skilled in the art. For instance, physical data blocks 305 may be stored on storage devices 310 (e.g., storage devices 130), which may be managed by a particular storage service provider via a storage virtualization layer 315, which converts logical block addresses into physical block addresses (that is, converting between a logical storage system that stores data in virtual storage locations and the actual underlying physical storage locations). A RAID (redundant array of independent or inexpensive disks) layer 320 may also be used to provide for RAID functionality, such as duplicate copies, parity storage, etc., as will be understood in the art. One or more logical units (LUNs, also referencing a logical unit number) 325 interact with the storage virtualization/RAID layers 315/320, and provide storage access for virtual machines 330 that logically represent one or more applications (apps) 335. Those skilled in the art will appreciate that the view shown in FIG. 3 is merely illustrative, and is not meant to limit the disclosure herein.

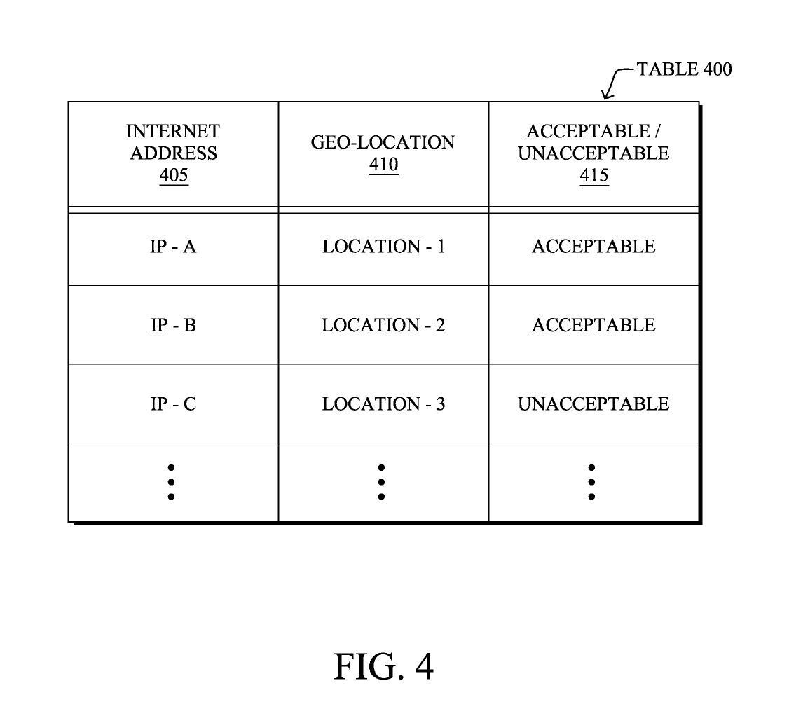

Operationally, according to the techniques described herein, the cloud storage system, generally (e.g., the service provider storage servers 125 and/or other suitable devices) determine “acceptability” of internet (Internet Protocol, IP) addresses, meaning those internet addresses that are allowed to store a particular customer's data. For example, acceptable and unacceptable internet addresses may be distinguished through a user-defined list (e.g., agreed upon IP addresses between customer and cloud service provider), such as the example list shown in FIG. 4. For instance, table 400 may consist of one or more addresses 405 (e.g., A, B, C, etc.) and their corresponding acceptable and/or unacceptable status 415, where the IP addresses are the destination IP addresses of destination data centers to which data may be stored and/or migrated, such as in the event of a failure in the source data center or for scheduled migration for disaster recovery, etc. Note that the list may comprise only acceptable address, or only unacceptable addresses, or both as shown.

Optionally, in one embodiment, the mapping table may that lists IP address with their corresponding geo-location 410 (e.g., location-1, -2, -3, etc.), thus allowing for distinguishing between acceptable and unacceptable geo-locations and corresponding internet addresses. In particular, certain service providers may be geographically dispersed, where the cloud destinations are known and can be mapped to geography. Though it is possible to perform automatic IP geo-location, the techniques herein are equally applicable to explicit mapping by the particular provider who is generally aware of the locations and addresses of their storage devices.

According to the techniques herein, data storage operations may create data transfers to a particular physical storage location, such as an initial storage, or also data transfers due to data “mirroring”, backups, or migration from one data center to another. The techniques herein thus determine whether the data storage/transfer is performed to a sane and agreed-upon destination, or else to a “rogue” (unacceptable) location.

In one embodiment, the storage servers are configured to determine (or report) the physical location of the data storage (i.e., where data blocks are physically being stored). However, in an illustrative embodiment, during the scheduled batch data migration of data for a particular customer, a probe may be inserted into the migration operation, where the probe may be a light-weight piece of code that provides a dynamic instrumentation that does not need the underlying storage source code. That is, the probe may comprise customer handler code that may be dynamically inserted into a corresponding cloud hypervisor (on a storage server associated with the storage operation), where the probe acts as code with a handler which is triggered and executed when a rogue operation occurs. Essentially, the probe extracts the destination IP address being issued in the cloud-based data storage operation (e.g., migration operation).

By checking the agreed-upon IP addresses in the IP address table 400, it can be determined whether the destination address is an acceptable internet address (i.e., whether it lies in the rogue zone), where in response to the destination address being an unacceptable internet address, some pre-defined action may be performed. For instance, based on either default configuration, or else based on customer agreements (e.g., service level agreements), the defined action may comprise such actions as sending an alert message to the customer admin console, preventing/dropping the storage operation, and so on. Illustratively, there may also be a provision to send a request to the customer/user to request user permission for the storage operation, such as, e.g., “We are migrating your data to IP address x.x.x.x, which lies in geo-location X. Do you approve or disapprove?” If the customer agrees, then the storage operation (e.g., migration) may be completed, otherwise it is abandoned. As a still further option, the operation may be deferred until the consent of the customer is obtained.

Note that the probe need only be inserted when needed, and may be removed when no longer needed, such as upon completion of the storage operation. Generally, this is because the probe works on behalf of the customer, and any workload which takes processing, memory, disk space, network resources, etc. is associated with a cost which should be assumed by the customer. As such, the techniques herein instrument the cloud hypervisor efficiently.

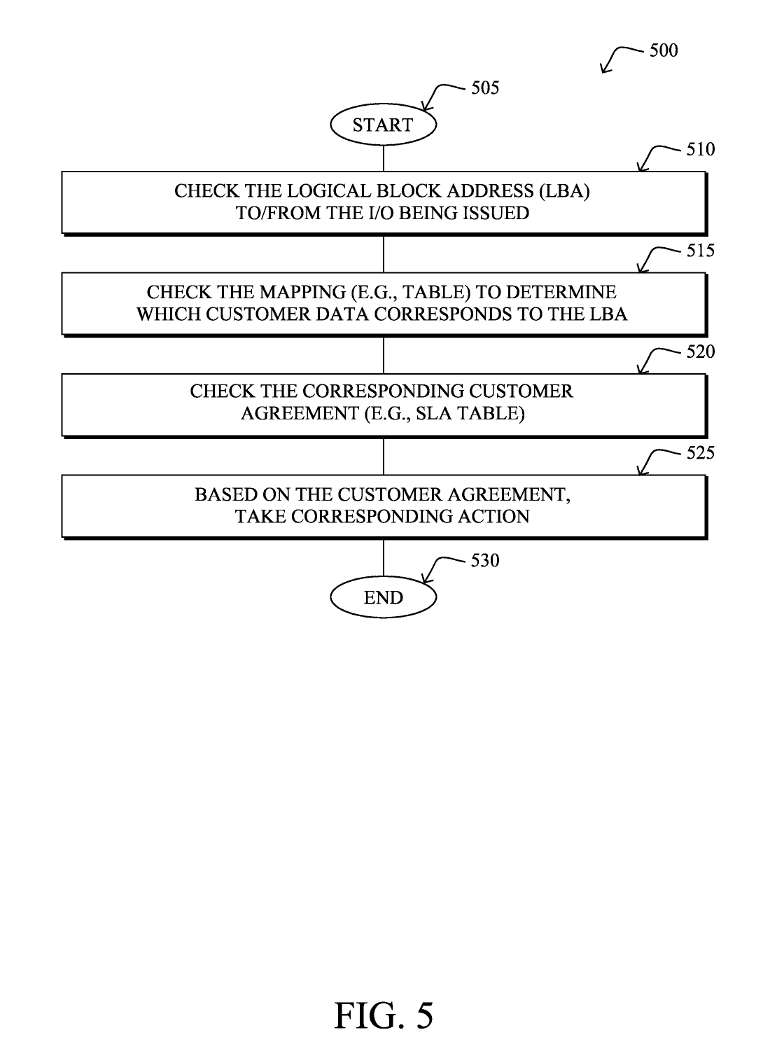

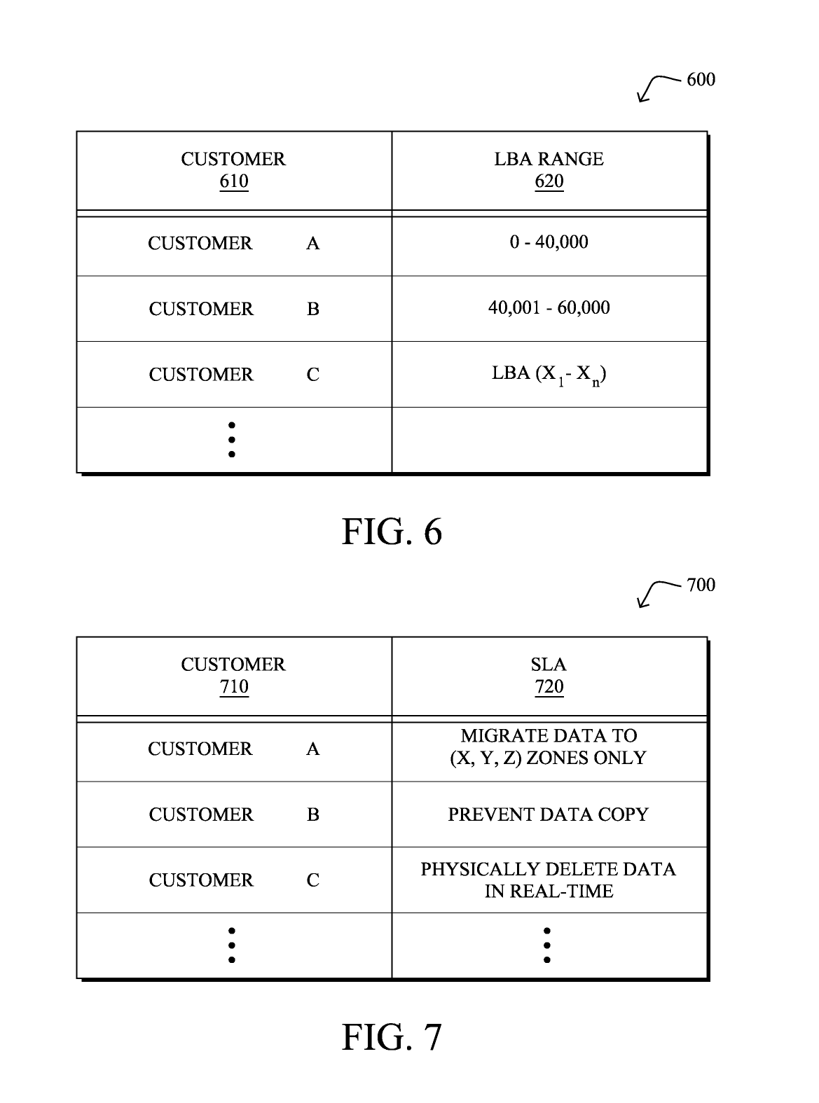

FIG. 5 illustrates an example simplified procedure 500 that demonstrates certain aspects of an illustrative embodiment herein. In particular, procedure 500 may start in step 505, and continues to step 510 where the storage system determines the physical location based on a logical block address (LBA) of the data blocks to/from which the input/output (I/O) command is being issued (i.e., where the data is being stored), as may be appreciated by those skilled in the art. In step 515, a mapping table may be checked to determine which customer data that LBA contains (i.e., which customer is associated with the data blocks for the storage operation). For instance, FIG. 6 illustrates an example customer mapping table 600, where customers A-C are mapped to corresponding LBA ranges 620 as shown. In other words, each logical data volume may be associated by a universally unique identifier (UUID). Assume, for example, that customer A has its data in volume v1, where v1 is a logical volume with a UUID of uuid1. The actual data of the customer will be in a certain contiguous or non-contiguous range of LBAs in the physical disk. As such, whenever I/O is issued to a block b1 with logical address a1, the mapping table 600 is accessed to see in which range the address a1 lies, i.e., which customer's data is it.

Referring again to FIG. 5, in step 520 the system checks with (looks up) a corresponding customer agreement (service level agreement, SLA) associated with the determined customer in order to determine, for that particular customer, to which zones (IP addresses mapped to zones) the data can be stored (e.g., replicated or base data transferred). For example, the table 400 shown in FIG. 4 may correspond to a particular customer, and defines such acceptable and/or unacceptable internet addresses. Alternatively, another type of table may be used, such as that shown in FIG. 7, where each customer 710 of the table 700 corresponds to a given SLA 720, and within that SLA is defined the set of rogue zones, general actions, and other rules as so defined.

Referring yet again to FIG. 5, in step 525, based on SLA, the system may take corresponding action, i.e., determining the defined action to take in response to unacceptable internet addresses based on the customer agreement. For instance, if the zone to which the data is being stored or transferred is a rogue zone, the operation may be either dropped or a message is sent to the customer console for consent and the migration operation is deferred and put in a queue, depending upon the customer's defined action. Once the defined action is complete (or the storage operation is permitted to complete), the example procedure 500 illustratively ends in step 530.

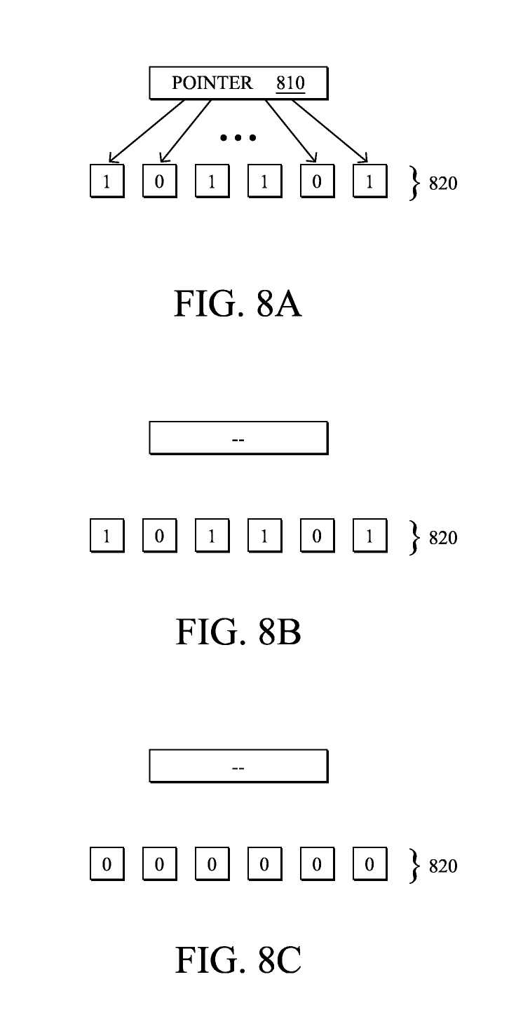

According to one or more additional or alternative embodiments herein, physical deletion of the data blocks may also be confirmed in response to a data deletion operation. For instance, a specific data deletion probe may be inserted into the volume manager that is triggered when the volume manager deletes a volume. During the data deletion, the handler of the probe is activated and checks the physical deletion of the customer data, e.g., ensuring that the data blocks pertaining to the deleted files are actually zeroed in the disks. For instance, as shown in FIG. 8A, assume that data is stored logically via one or more pointers 810 (e.g., LBAs) which correspond to underlying physical data blocks 820, and that such stored data is an example set of bit values “101101”. As shown in FIG. 8B, a logical deletion of the data may merely remove the pointer 810, while the physical data blocks may still read “101101”. Normally, this may not be a problem, as the data is generally inaccessible, and may eventually be overwritten by other data. However, for highly secure data, such physical data blocks may be read/restored, and the deleted data, since only logically deleted, may be obtained.

For this reason, the techniques herein may also confirm physical deletion of the data blocks in response to a data deletion operation using the data deletion probe. As such, the techniques herein may check to see whether the physical data has been deleted or “zeroed out”, as shown in FIG. 8C, where the underlying data blocks 820 have been set to “000000”, accordingly. If data is not deleted physically, the techniques herein may perform some pre-defined action, such as sending a high alert message to the customer admin console (e.g., saying “certain high security related data not deleted properly or permanently”). Notably, based on the size of the data volume, it may be possible to create a set of random blocks which can be scanned to determine whether the data related to a particular customer was zeroed or not whenever the customer issues a data deletion request, as opposed to checking each and every physical data block.

Further, according to one or more embodiments herein, logic may be added (e.g., to the disk array firmware where the data is physically present) which may detect any access (read/copy/etc.) of the data that occurs. In other words, this logic may track the I/O read or writes of data, and that information may also be propagated to the customer. For instance, physically assume an LBA range (0-40000) is allocated to a customer A. The firmware would track how many times data blocks within this LBA range is accessed. This will provide information to the customer that the data has been accessed (e.g., physically moved—either read/written). So if the customer agreement (SLA) is not to move the data physically, then the customer can know that the cloud service provider has violated the agreement. Other types of access violations based on the number or type of accesses to the data blocks may also be performed according to this added logic.

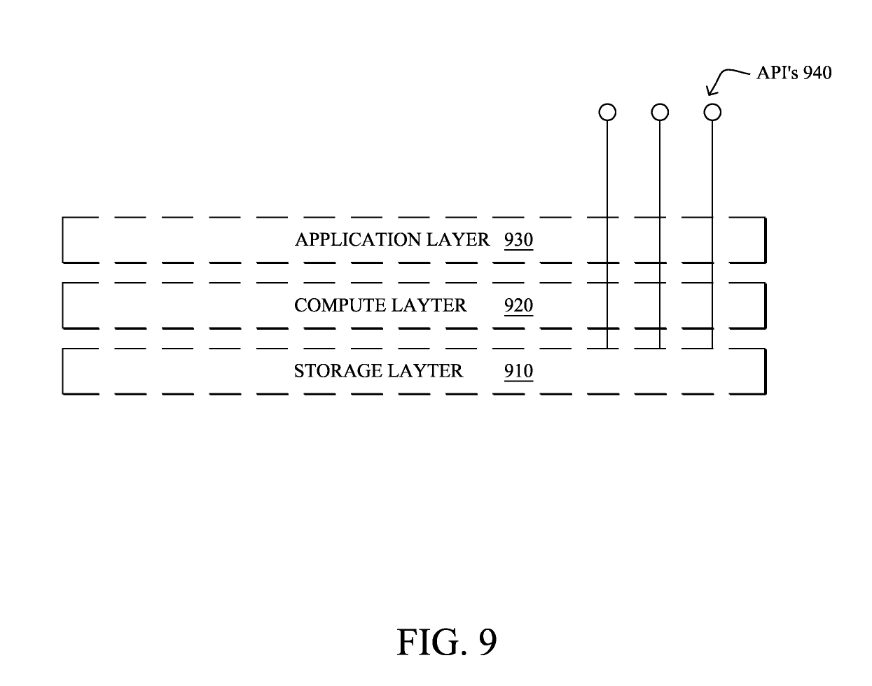

Additionally, according to one or more embodiments herein, the cloud service provider may be configured to expose various application programming interfaces (APIs) so that certain operations described above can also be performed using those APIs. For instance, as shown in FIG. 9, a storage layer 910, a compute layer 920, and an application layer 930 may each be accessed via one or more APIs 940. Through interfaces in the form of APIs, the customer can use and gain more control over the underlying data (relevant controls, not absolute control), where associated handler code is invoked in response to particular storage events, such as to instrument/probe various points which are desired from a customer perspective. Illustrative APIs that may be exposed to the customer may comprise:

API_control_data_deletion( );
API_control_data_migration( ); and
API_control_data_illegal_copy( ).

For example, when a data deletion event occurs for customer A, the invoked handler may be probe code which checks for physical data deletion. When data migration of customer A occurs, then the invoked handler may be probe code which checks the sanity of the zone to which data is migrated. As another example, if an illegal copy of customer A's data occurs, then the invoked handler may be probe code which checks the illegal copy and informs customer A. Notably, where each customer has their own assigned data block range (e.g., contiguous or not), each customer may use a private key to access their data blocks (LBAs) and monitor them to see whether their data is safe or not, e.g., by some customer technique implemented by the customer itself (e.g., customer A can provide their own probe to access their data range, while customer B accesses their own corresponding data using a different private key).

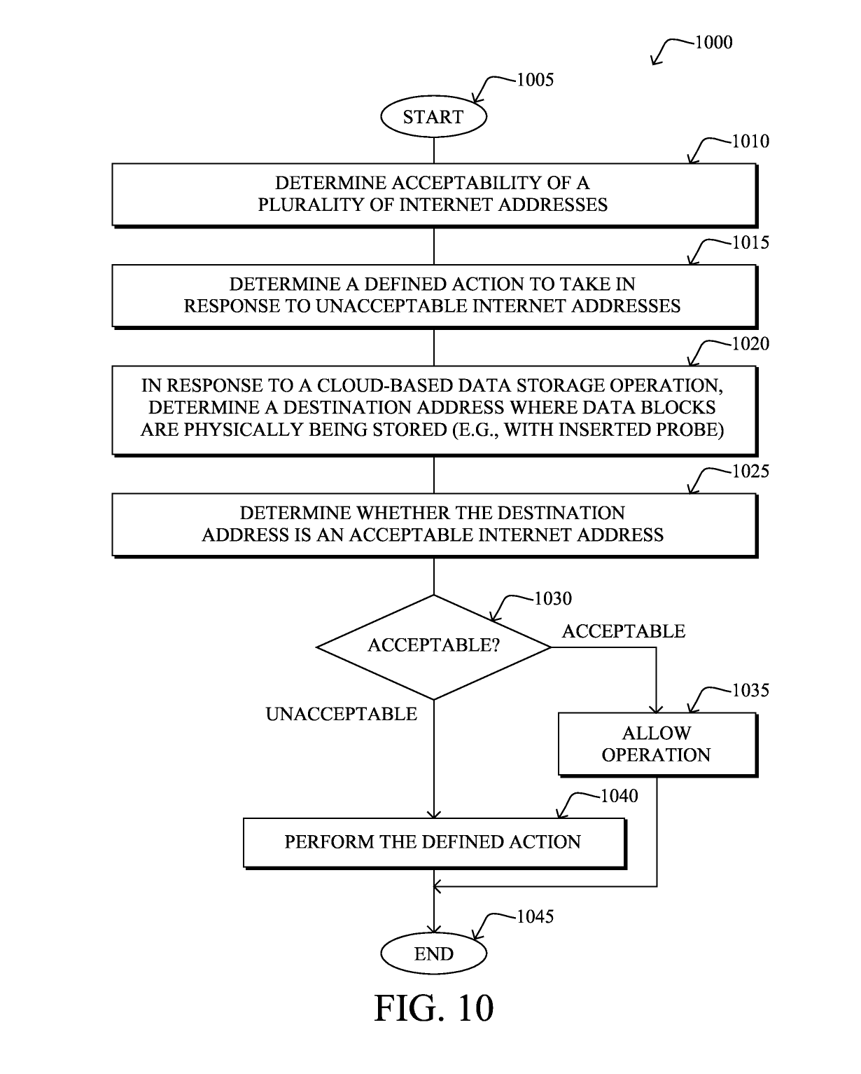

The techniques herein thus manage rogue cloud provider operations, and FIG. 10 illustrates an example simplified procedure 1000 for managing rogue cloud provider operations in accordance with one or more embodiments described herein. The procedure 1000 may start at step 1005, and continues to step 1010, where, as described in greater detail above, a cloud storage system determines acceptability of a plurality of internet addresses (e.g., table 400), and also in step 1015 determines a defined action to take in response to unacceptable internet addresses (e.g., alert a user, preventing the storage operation, requesting user permission, etc.). In response to a cloud-based data storage operation, in step 1020 the system (e.g., the inserted probe) determines a destination address where data blocks are physically being stored, and in step 1025 determines whether the destination address is an acceptable internet address. If not (step 1030), then in step 1035 the system performs the defined action. Otherwise, if the address is acceptable (step 1030), then in step 1040 the system allows the operation. The illustrative procedure 1000 ends in step 1045.

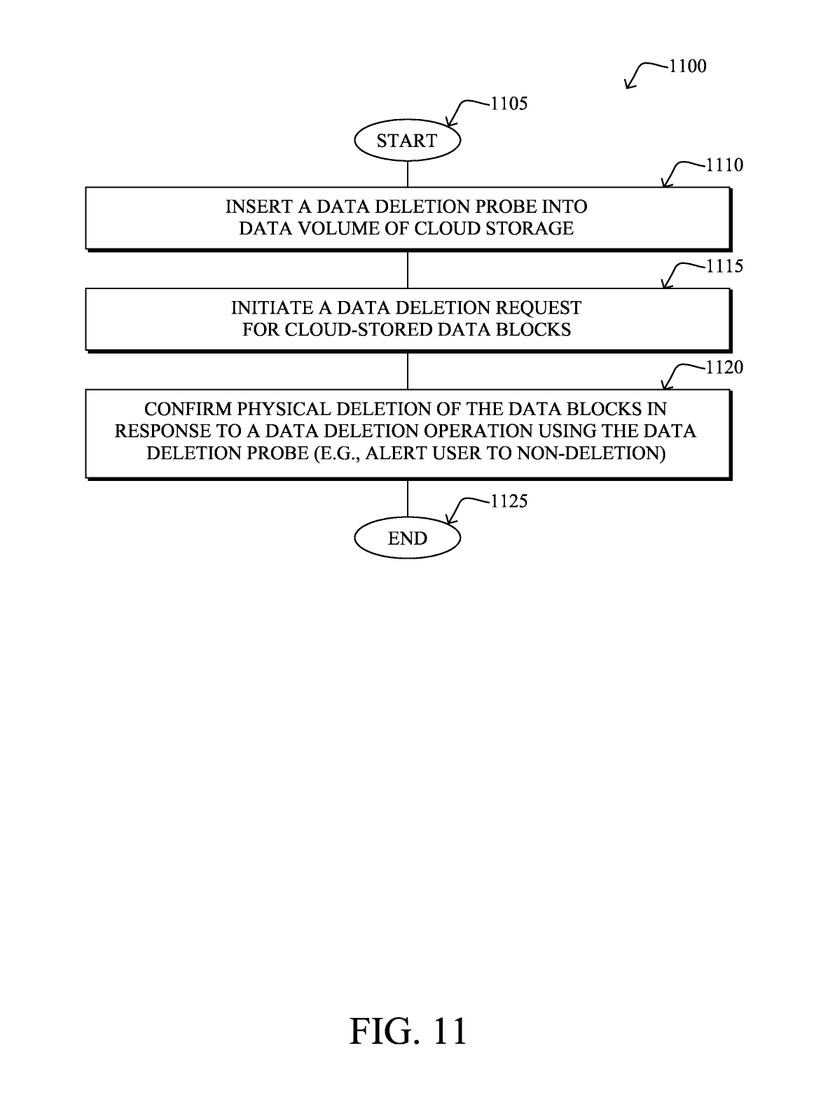

Additionally, FIG. 11 illustrates another example simplified procedure 1100 for managing rogue cloud provider operations in accordance with one or more embodiments described herein, particularly with regard to data deletion. The procedure 1100 may start at step 1105, and continues to step 1110, where, as described in greater detail above, a data deletion probe may be inserted in to the data volume of the cloud storage. In step 1115, the cloud-based storage system initiates a data deletion request for cloud-stored data blocks, which in turn triggers the data deletion probe. The probe may then be used to confirm physical deletion of the data blocks in response to a data deletion operation in step 1120. Illustratively, as described above, if the data has not been deleted (physically), then a user/admin may be alerted to such non-deletion, accordingly. The procedure 1100 then illustratively ends in step 1125.

It should be noted that while certain steps within procedures 500, 1000, and 1100 may be optional as described above, the steps shown in FIGS. 5, 10, and 11 are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures 500, 1000, and 1100 are described separately, certain steps from each procedure may be incorporated into each other procedure, and the procedures are not meant to be mutually exclusive.

The techniques described herein, therefore, provide for detecting and preventing rogue cloud provider operations in a computer network. In particular, the techniques herein alleviate certain security threats associated with storing data within the public cloud, which in turn leads to customer confidence, by giving the customer perspective of what happens “behind the scenes” with their data. That is, since in the cloud the physical layer is abstracted, unless the customer has access to the physical layer, they cannot properly monitor the authenticity of the data. The techniques herein provide transparency to the customer, and provide deferral of suspicious operations pending customer consent. Moreover, the techniques herein operate at the block level (as opposed to at the file level abstraction), so the techniques are able to manage rogue operations at the block level, accordingly.

While there have been shown and described illustrative embodiments that provide for management of rogue cloud provider operations, it is to be understood that various other adaptations and modifications may be made within the spirit and scope of the embodiments herein. For example, the embodiments have been shown and described herein with relation to certain cloud storage protocols, such as according to certain block storage protocols. However, the embodiments in their broader sense are not as limited, and may, in fact, be used with other types of protocols used for cloud data storage not specifically mentioned herein, as will be understood by those skilled in the art.

The foregoing description has been directed to specific embodiments. It will be apparent, however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
determining acceptability of a plurality of internet addresses;
determining a defined action to take in response to unacceptable internet addresses;
in response to a cloud-based data storage operation, determining a destination address where data blocks are physically being stored;
determining whether the destination address is an acceptable internet address; and
in response to the destination address being an unacceptable internet address, performing the defined action.

2. The method as in claim 1, wherein determining acceptability comprises:
mapping internet address to geo-locations; and
distinguishing between acceptable and unacceptable geo-locations and corresponding internet addresses.

3. The method as in claim 1, wherein determining acceptability comprises:
distinguishing between acceptable and unacceptable internet addresses through a user-defined list.

4. The method as in claim 1, wherein the defined action comprises:
alerting a user that the destination address is an unacceptable internet address.

5. The method as in claim 1, wherein the defined action comprises:
preventing the storage operation.

6. The method as in claim 1, wherein the defined action comprises:
requesting user permission for the storage operation.

7. The method as in claim 1, wherein determining the destination address where data blocks are physically being stored comprises:
inserting a probe into the storage operation to determine the destination address.

8. The method as in claim 7, further comprising:
removing the probe upon completion of the storage operation.

9. The method as in claim 7, wherein the probe comprises customer handler code on a storage server associated with the storage operation.

10. The method as in claim 1, further comprising:
tracking a number of accesses to the data blocks; and
determining an access violation based on the number of accesses.

11. The method as in claim 1, wherein determining the destination address where data blocks are physically being stored is based on a logical block address of the data blocks.

12. The method as in claim 1, further comprising:
determining a customer associated with the data blocks for the storage operation; and
looking up a customer agreement associated with the customer,
wherein determining acceptability of the plurality of internet addresses is based on the customer agreement.

13. The method as in claim 1, further comprising:
confirming physical deletion of the data blocks in response to a data deletion operation.

14. Logic encoded in one or more non-transitory tangible media for execution and when executed by a machine operable to:
determine acceptability of a plurality of internet addresses;
determine a defined action to take in response to unacceptable internet addresses;
in response to a cloud-based data storage operation, determine a destination address where data blocks are physically being stored;
determine whether the destination address is an acceptable internet address; and
in response to the destination address being an unacceptable internet address, perform the defined action.

15. The logic as in claim 14, wherein the logic when executed to determine acceptability is further operable to:
map internet address to geo-locations; and
distinguish between acceptable and unacceptable geo-locations and corresponding internet addresses.

16. The logic as in claim 14, wherein the logic when executed to determine acceptability is further operable to:
distinguish between acceptable and unacceptable internet addresses through a user-defined list.

17. The logic as in claim 14, wherein the defined action is selected from a group consisting of:
alerting a user that the destination address is an unacceptable internet address;
preventing the storage operation; and
requesting user permission for the storage operation.

18. The logic as in claim 14, wherein the logic when executed to determine the destination address where data blocks are physically being stored is further operable to:
insert a probe into the storage operation to determine the destination address.

19. The logic as in claim 14, wherein the logic when executed is further operable to:
confirm physical deletion of the data blocks in response to a data deletion operation.

20. Logic encoded in one or more non-transitory tangible media for execution and when executed by a machine operable to:
insert a data deletion probe into a data volume of a cloud storage system;
initiate a data deletion request for cloud-stored data blocks of the data volume; and
confirm physical deletion of the data blocks in response to a data deletion operation using the data deletion probe.
